(19) United States
(12) Patent Application Publication
(10) Pub. No.: US 2018/0267245 A1
(43) Pub. Date: Sep. 20, 2018

(54) OPTICAL ISOLATOR AND OPTICAL MODULE

(71) Applicant: FUJITSU LIMITED, Kawasaki-shi (JP)

(72) Inventor: Hirotomo Izumi, Kawasaki (JP)

(73) Assignee: FUJITSU LIMITED, Kawasaki-shi (JP)

(21) Appl. No.: 15/898,758

(22) Filed: Feb. 19, 2018

(30) Foreign Application Priority Data
Mar. 17, 2017 (JP) 2017-052089

(51) Int. Cl. G02B 6/27; G02B 6/122; G02F 1/095; G02F 1/035

(52) U.S. Cl. CPC G02B 6/2746; G02F 1/035; G02F 1/0955; G02B 6/122

(57) ABSTRACT

An apparatus includes a first coupler configured to input input light through an input waveguide and branch the input light into first and second branch waveguides; a second coupler configured to combine the first and second branch waveguides and to output the output light through an output waveguide; a phase adjuster having a birefringent property, provided to the second branch waveguide; and a polarization converter having a birefringent property, provided to the output waveguide and configured to, when reflected light corresponding to the output light is input to the output waveguide, convert a polarization state of the reflected light such that a first part of the reflected light for traveling through the first path and a second part of the reflected light for traveling through the second path are in antiphase at the input waveguide.

### CROSS-REFERENCE TO RELATED APPLICATION

This application is based upon and claims the benefit of priority of the prior Japanese Patent Application No. 2017-52089, filed on Mar. 17, 2017, the entire contents of which are incorporated herein by reference.

### FIELD

The embodiment discussed herein is related to an optical isolator and an optical module.

### BACKGROUND

Some optical source such as a semiconductor laser emits optical source light, and receives, as reflected light, part of the optical source light reflected and returned from an optical device or the like located on the downstream side of the optical source. When the reflected light enters the optical source, the characteristics of the optical source are deteriorated, and the optical source fails to provide normal optical source light. In some cases, an optical isolator that blocks the return of reflected light to the optical source is provided at an output end side of the optical source.

As optical isolators, there are bulk optical isolators not using optical waveguides and waveguide optical isolators using optical waveguides. In a bulk optical isolator, optical devices used to block reflected light are accommodated in a housing, and accordingly the housing having a sufficiently large size is to be arranged. From the viewpoint of size reduction of apparatuses, it is difficult to integrate such a bulk optical isolator together with the optical source in a substrate. In recent years, various studies have been made of waveguide optical isolators in which an optical device to block reflected light is provided to an optical waveguide on a substrate.

For example, a waveguide optical isolator in which a magneto-optical crystal to turn the direction of polarization of reflected light is joined to an optical waveguide on the substrate is disclosed.

Related techniques are disclosed in, for example, Japanese Laid-open Patent Publication No. 2003-302603.

Meanwhile, magneto-optical crystals have larger coefficients of thermal expansion than that of silicon, which is generally used as the material for substrates and optical waveguides on the substrates. In such a waveguide optical isolator where a magneto-optical crystal is joined to an optical waveguide on a substrate, a frequent change in the temperature around the optical isolator causes the magneto-optical crystal to thermally expand and sometimes separate from the optical waveguide on the substrate. For example, when an optical source that generates heat is placed near the optical isolator, the magneto-optical crystal thermally expanded due to the heat from the optical source may separate from the optical waveguide on the substrate. When the magneto-optical crystal separates from the waveguide on the substrate, the performance of the optical isolator blocking reflected light would decrease.

The technique of the disclosure was made in the light of the above-described matters, and an object of the disclosure is to provide an optical isolator and an optical module which reduce the decrease in the reflected light blocking performance due to changes in temperature.

### SUMMARY

According to an aspect of the embodiments, an apparatus includes a first optical coupler configured to input input light through an input waveguide and branch the input light into first and second branch waveguides; a second optical coupler configured to combine the first and second branch waveguides and to output the output light through an output waveguide; a phase adjuster having a birefringent property, provided to the second branch waveguide; and a polarization converter having a birefringent property, provided to the output waveguide and configured to, when reflected light corresponding to the output light is input to the output waveguide, convert a polarization state of the reflected light such that a first part of the reflected light for traveling through the first path and a second part of the reflected light for traveling through the second path are in antiphase at the input waveguide.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a perspective view illustrating the configuration of an optical isolator according to an embodiment;

FIG. 2 is a plan view illustrating the configuration of the optical isolator according to the embodiment;

FIG. 3 is a view illustrating a detailed configuration of a phase adjuster as a one-wave plate;

FIG. 4 is a view illustrating a detailed configuration of a phase adjuster as a half-wave plate;

FIG. 5 is a view illustrating a detailed configuration of a polarization converter;

FIG. 6 is a view illustrating a cross-sectional profile of an optical waveguide to be processed;

FIG. 7 is a diagram illustrating a correspondence relationship between width t of the optical waveguide to be processed and an effective index neff of refraction of the optical waveguide to be processed in a direction vertical to the surface of the substrate;

FIG. 8 is a diagram illustrating a correspondence relationship between width w of the optical waveguide to be processed and the effective index neff of refraction in a direction parallel to the surface of the substrate;

FIG. 9 is a diagram for explaining the operation of the optical isolator to output output light corresponding to input light;

FIG. 10 is a diagram for explaining the operation of the optical isolator to output output light corresponding to input light;

FIG. 11 is a diagram for explaining the operation of the optical isolator to block reflected light corresponding to the output light;

FIG. 12 is a diagram for explaining the operation of the optical isolator to block reflected light corresponding to the output light; and

FIG. 13 is a diagram illustrating a configuration of an optical module including the optical isolator according to the aforementioned embodiment.

### DESCRIPTION OF EMBODIMENTS

Hereinafter, a description is given of an embodiment of an optical isolator and an optical modulator disclosed in the application in detail with reference to the drawings. The embodiment will not limit the disclosed technologies.

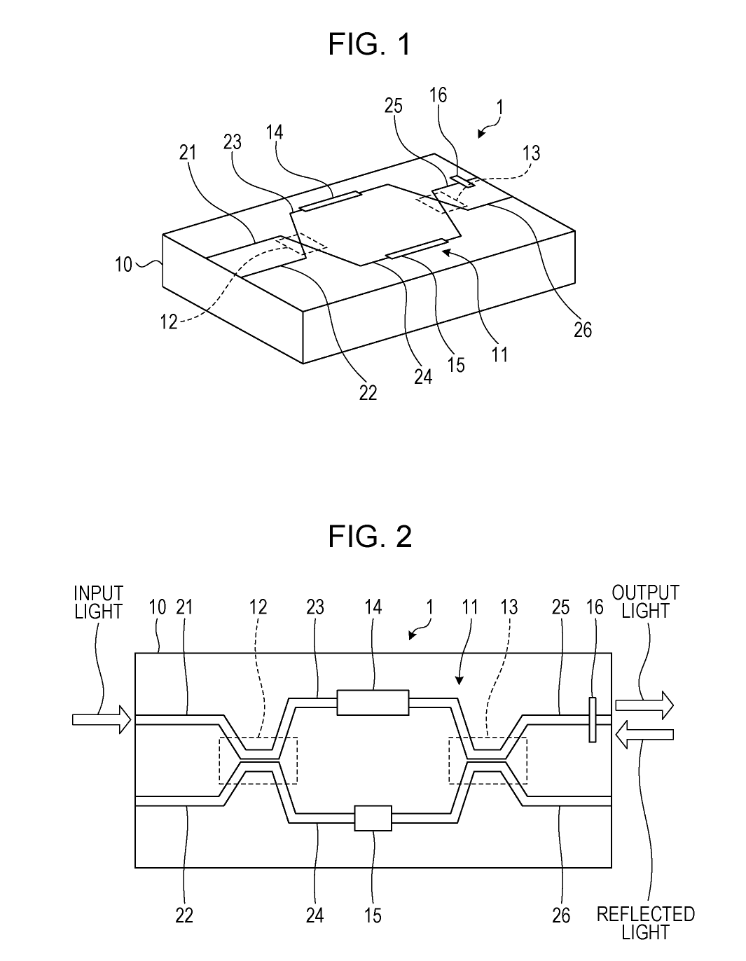

FIG. 1 is a perspective view illustrating the configuration of an optical isolator 1 according to the embodiment. FIG. 2 is a plan view illustrating the configuration of the optical isolator 1 according to the embodiment. As illustrated in FIGS. 1 and 2, the optical isolator 1 includes a substrate 10, an optical waveguide 11, couplers 12 and 13, phase adjusters 14 and 15, and a polarization converter 16.

Hereinafter, light polarized parallel to the surface of the substrate 10 is referred to as p-polarized light while light polarized vertically to the surface of the substrate 10 is referred to as s-polarized light. In another embodiment, the phase adjusters 14 and 15 may be replaced by birefringent waveguides that have the same functions corresponding to the phase adjusters 14 and 15, respectively. The phase adjusters 14 and 15 may include branch waveguides 23 and 24 that have birefringent properties, respectively.

The substrate 10 is a substrate on or in which the optical waveguide 11, couplers 12 and 13, phase adjusters 14 and 15, and polarization converter 16 are formed. The substrate 10 may be made of silicon, for example.

The optical waveguide 11 is formed on or in the substrate 10 and includes: an input waveguide 21 configured to receive input light; branch waveguides 23 and 24, and an output waveguide 25 configured to output output light corresponding to the input light. The optical waveguide 11 further includes: an auxiliary waveguide 22 adjacent to the input waveguide 21; and an auxiliary waveguide 26 adjacent to the output waveguide 25. The optical waveguide 11 may be made of the same material as that of the substrate 10, such as silicon, for example. The optical waveguide 11 may employ a ridge optical waveguide, for example. In the embodiment, it is assumed that the input light input to the input waveguide 21 is p-polarized light and the polarization state of the input light is parallel to the surface of the substrate 10.

The coupler 12 connects the input waveguide 21, auxiliary waveguide 22, and branch waveguides 23 and 24 for splitting and combining light. In the process of splitting a ray of light, the coupler 12 generates two rays of light with a phase difference of π/2 therebetween. In the process of combining two rays of light, the coupler 12 shifts the phase of one of the rays by π/2 and combines the ray with the phase shifted by π/2 with the other ray.

The coupler 13 connects the output waveguide 25, auxiliary waveguide 26, and branch waveguides 23 and 24 for splitting and combining light. In the process of splitting a ray of light, the coupler 13 generates two rays of light with a phase difference of π/2 therebetween. At combining two rays of light, the coupler 13 shifts the phase of one of the rays by π/2 and combines the ray with the phase shifted by π/2 with the other ray.

The phase adjuster 14 is provided to the branch waveguide 23. The phase adjuster 14 is a one-wave plate configured to adjust the phase of light for traveling through a first path depending on the polarization state of the light. Specifically, when the polarization state of light for traveling through the first path is equal to the polarization state of the input light (or when the light for traveling through the first path is p-polarized light), the phase adjuster 14 shifts the phase of the light for traveling through the first path by 2π. On the other hand, when the polarization state of light for traveling through the first path is perpendicular to the polarization state of the input light (or when the light for traveling through the first path is s-polarized light), the phase adjuster 14 does not shift the phase of the light for traveling through the first path. Herein, the “first path” is a path including the coupler 12, branch waveguide 23, and coupler 13. The light for traveling through the first path includes light for traveling through the first path in the travel direction of the input light input to the input waveguide 21 and light for traveling through the first path in the direction opposite to the travel direction of the input light. The phase adjuster 14 may be made of the same material as that of the substrate 10 (silicon, for example).

The phase adjuster 15 is provided to the branch waveguide 24. The phase adjuster 15 is a half-wave plate configured to adjust the phase of light for traveling through a second path depending on the polarization state of the light. Specifically, when the polarization state of light for traveling through the second path is equal to the polarization state of the input light (or when the light for traveling through the second path is p-polarized light), the phase adjuster 15 shifts the phase of the light for traveling through the second path by π. On the other hand, when the polarization state of light for traveling through the second path is perpendicular to that of the input light (or when the light for traveling through the second path is s-polarized light), the phase adjuster 15 does not shift the phase of the light for traveling through the second path. Herein, the “second path” is a path including the coupler 12, branch waveguide 24, and coupler 13. The light for traveling through the second path includes light for traveling through the second path in the travel direction of the input light input to the input waveguide 21 and light for traveling through the second path in the direction opposite to the travel direction of the input light. The phase adjuster 15 may be made of the same material as that of the substrate 10 (silicon, for example).

The polarization converter 16 is provided to the output waveguide 25. The polarization converter 16 converts the polarization state of light input from the coupler 13 into circular polarization to generate output light to be output from the output waveguide 25. On the other hand, when reflected light corresponding to the output light is input to the output waveguide 25, the polarization converter 16 converts the polarization state of the reflected light such that the light for traveling through the first path and light for traveling through the second path may be in antiphase at the input waveguide 21. Specifically, the polarization converter 16 converts the polarization state of the reflected light into the polarization state perpendicular to that of the input light. When the polarization state of the reflected light is converted into the polarization state perpendicular to that of the input light, the polarization state of the reflected light is vertical to the surface of the substrate 10. When the polarization state of the reflected light is converted into the polarization state perpendicular to that of the input light, therefore, the reflected light, the light for traveling through the first path corresponding to the reflected light, and the light for traveling through the second path corresponding to the reflected light are s-polarized light.

The polarization converter 16 may be made of a material (polyimide, for example) which is different from the material of the substrate 10 and has a coefficient of thermal expansion closer to that of the substrate 10 than to that of magneto-optical crystals. The polarization converter 16 may employ a quarter-wave plate. The polarization converter 16 may also employ a birefringent waveguide having a function as the quarter-wave plate and the polarization converter 16 may include the optical waveguide 25 that has a birefringent property.

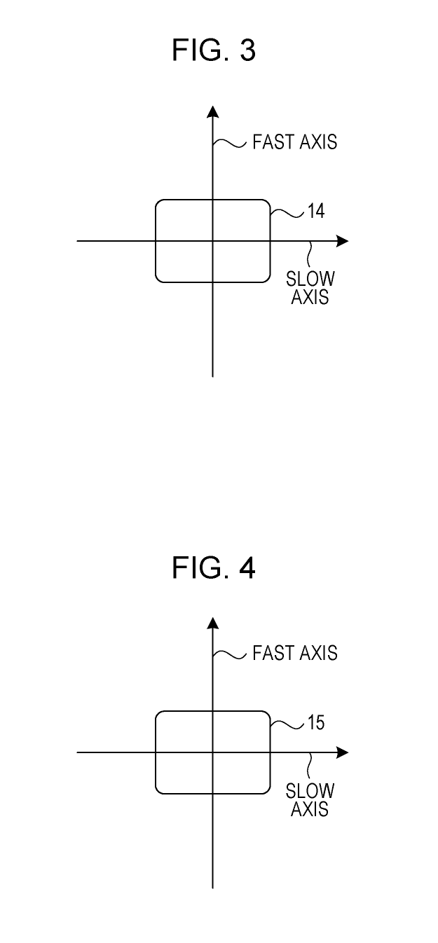

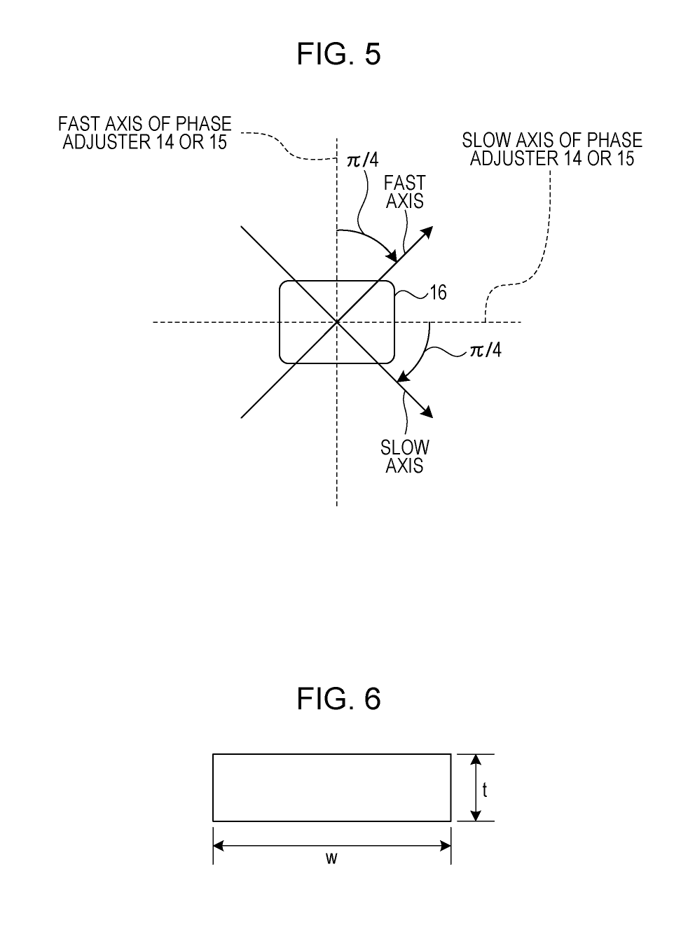

Next, a description is further given of the phase adjusters 14 and 15 and polarization converter 16 in detail with reference to FIGS. 3 to 5. FIG. 3 is a view illustrating a detailed configuration of the phase adjuster 14 as a one-wave plate. FIG. 4 is a view illustrating a detailed configuration of the phase adjuster 15 as a half-wave plate. FIG. 5 is a view illustrating a detailed configuration of the polarization converter 16.

The phase adjusters 14 and 15 and polarization converter 16 are birefringent crystals having two optical axes (f-axis and s-axis) with two different indices of refraction as illustrated in FIGS. 3 to 5. The f-axis, which is one of the two optical axes, is an axis with a smaller index of refraction than that of the s-axis and is called a fast axis. The s-axis, which is the other optical axis, is an axis with a larger index of refraction than that of the f-axis and is called a slow axis.

The phase adjusters 14 and 15 are respectively arranged as illustrated in FIGS. 3 and 4 such that the directions of the two optical axes (f- and s-axes) of the phase adjuster 14 respectively coincide with those of the two optical axes (f- and s-axes) of the phase adjuster 15. For example, the phase adjusters 14 and 15 may be arranged such that the s-axis is parallel to the surface of the substrate 10 while the f-axis is vertical to the surface of the substrate 10. When the index of refraction of the optical waveguide 11 formed on or in the substrate 10 is the same as the index of refraction along the f-axis of the phase adjuster 14 or 15, the phase of p-polarized light input to the phase adjuster 14 is shifted by 2π. The phase of p-polarized light input to the phase adjuster 15 is shifted by π.

As illustrated in FIG. 5, the polarization converter 16 is arranged such that the directions of the two optical axes (f- and s-axes) of the polarization converter 16 are rotated by π/4 respectively with respect to the directions of the two optical axes (f- and s-axes) of the phase adjuster 14 or 15. When p-polarized light is input to the polarization converter 16, the component of the input p-polarized light along the f-axis and the component of the input p-polarized light along the s-axis have a phase difference of π/2 therebetween, so that the circularly-polarized light, the polarization state of which is circular polarization, is output from the polarization converter 16. When circularly-polarized light is input to the polarization converter 16, the component of the input circularly-polarized light along the f-axis and the component of the input circularly-polarized light along the s-axis have a phase difference of π/2 therebetween, so that s-polarized light is output from the polarization converter 16.

Next, with reference to FIGS. 6 to 8, a description is given of a method of manufacturing the phase adjusters 14 and 15. The phase adjusters 14 and 15 are manufactured by processing an optical waveguide (hereinafter, referred to as an optical waveguide to be processed) which is made of the same material as that of the optical waveguide 11 on the substrate 10. FIG. 6 is a diagram illustrating a cross-sectional profile of the optical waveguide to be processed. As illustrated in FIG. 6, the width of the optical waveguide to be processed in the direction vertical to the surface of the substrate 10 is defined as t while the width thereof in the direction parallel to the surface of the substrate 10 is defined as w.

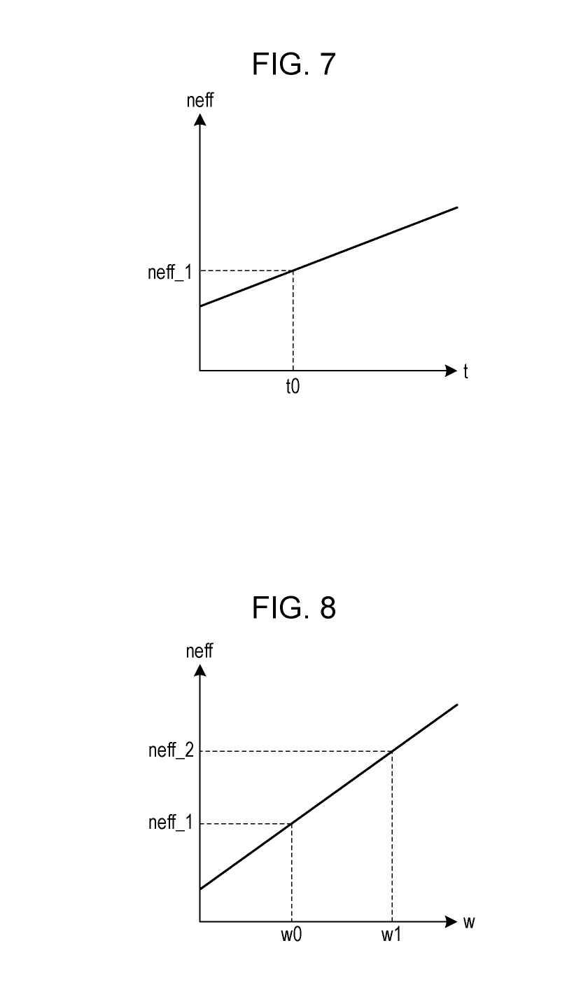

FIG. 7 is a diagram illustrating the correspondence relationship between the width t of the optical waveguide to be processed and the effective index neff of refraction of the optical waveguide to be processed in the direction vertical to the surface of the substrate 10. FIG. 8 is a diagram illustrating the correspondence relationship between the width w of the optical waveguide to be processed and the effective index neff of refraction of the optical waveguide to be processed in the direction parallel to the surface of the substrate 10.

As illustrated in FIGS. 7 and 8, when the widths t and w are set to t0 and w0, respectively, the effective index neff of refraction of the optical waveguide to be processed in the direction vertical to the surface of the substrate 10 and the effective index neff of refraction in the direction parallel to the same are both neff_1. On the other hand, when the widths t and w are set to t0 and w1, respectively, the effective index neff of refraction of the optical waveguide to be processed in the direction vertical to the surface of the substrate 10 is neff_1 while the effective index neff of refraction in the direction parallel to the same is neff 2. When the widths t and w are set to t0 and w1, respectively, therefore, the optical waveguide to be processed is a birefringent crystal having two optical axes (the f- and s-axes) with different indices of refraction. Herein, the effective index neff of refraction (=neff_2) in the direction parallel to the surface of the substrate 10 is larger than the effective index neff of refraction (=neff_1) in the direction vertical to the surface of the substrate 10. The axis in the direction parallel to the surface of the substrate 10 is the s-axis of the optical waveguide to be processed, and the axis in the direction vertical to the surface of the substrate 10 is the f-axis of the optical waveguide to be processed.

The difference between the effective index neff of refraction (=neff_2) in the direction parallel to the surface of the substrate 10 and the effective index neff of refraction (=neff_1) in the direction vertical to the surface of the substrate 10 is translated to a phase difference φ between the components along the f- and s-axes by the following expression (1).

φ=2π·(neff_2−neff_1)−L/λ (1)

In the expression (1), λ is the wavelength of light, and L is the thickness of the optical waveguide to be processed.

The phase adjuster 14 may be manufactured by processing the optical waveguide to be processed to adjust the thickness L such that the phase difference φ of the expression (1) is 2π. The phase adjuster 15 may be manufactured by processing the optical waveguide to be processed to adjust the thickness L such that the phase difference φ of the expression (1) is π.

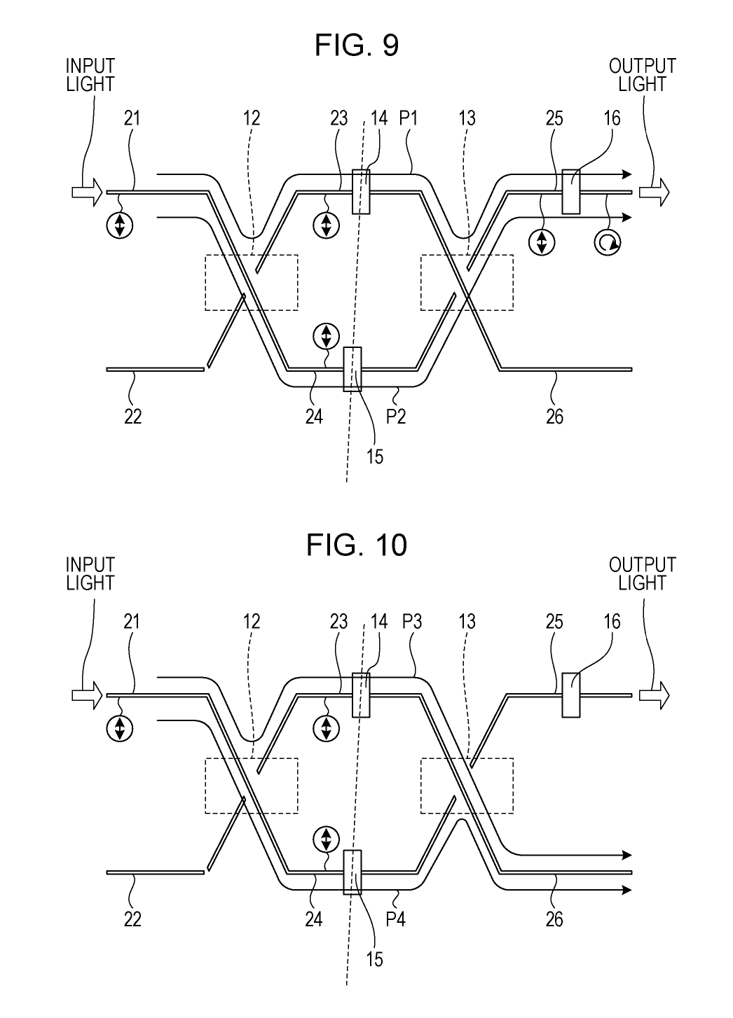

Next, a description is given of the operation of the optical isolator 1 to output the output light corresponding to the input light. FIGS. 9 and 10 are diagrams for explaining the operation of the optical isolator 1 to output the output light depending on the input light.

In FIG. 9, the input waveguide 21, first path, and output waveguide 25 constitute a route P1, and the input waveguide 21, second path, and output waveguide 25 constitute a route P2. In FIG. 10, the input waveguide 21, first path, and auxiliary waveguide 26 constitute a route P3, and the input waveguide 21, second path, and auxiliary waveguide 26 constitute a route P4.

A description is given of the operation of the optical isolator 1 in the routes P1 and P2 illustrated in FIG. 9. The coupler 12 splits the input light input from the input waveguide 21 to generate first light to be input to the branch waveguide 23 and second light which is to be input to the branch waveguide 24 and has a phase shift of π/2 with respect to the first light. The first light and second light are p-polarized light because the input light input from the input waveguide 21 is p-polarized light.

The phase adjuster 14 shifts the phase of the first light, which is p-polarized light, by 2π for adjustment of the phase of light for traveling through the first path. The phase adjuster 15 shifts the phase of the second light, which is p-polarized light, by π for adjustment of the phase of light for traveling through the second path.

The coupler 13 shifts the phase of the second light by π/2 to combine the second light with the phase shifted by 2π in total with the first light with the phase shifted by 2π in total at the output waveguide 25. In other words, the first light (light for traveling through the first path) and second light (light for traveling through the second path) are in phase at the output waveguide 25 and are combined at the output waveguide 25. The combined light of the first and second light is then input to the polarization converter 16.

The polarization converter 16 converts the polarization state of the combined light of the first and second light into circular polarization to generate circularly-polarized output light. The output light generated by the polarization converter 16 is output from the output waveguide 25.

A description is given of the operation of the optical isolator 1 in the routes P3 and P4 illustrated in FIG. 10. The coupler 12 splits the input light input from the input waveguide 21 to generate the first light to be input to the branch waveguide 23 and the second light which is to be input to the branch waveguide 24 and has a phase shift of π/2 with respect to the first light. The first light and second light are p-polarized light because the input light is p-polarized light.

The phase adjuster 14 shifts the phase of the first light, which is p-polarized light, by 2π for adjustment of the phase of light for traveling through the first path. The phase adjuster 15 shifts the phase of the second light, which is p-polarized light, by π for adjustment of the phase of light for traveling through the second path.

The coupler 13 shifts the phase of the first light by π/2 to combine the first light with the phase shifted by 5π/2 in total with the second light with the phase shifted by 3π/2 in total at the auxiliary waveguide 26. The first light (light for traveling through the first path) and the second light (light for traveling through the second path) are in antiphase at the auxiliary waveguide 26 and are canceled with each other at the auxiliary waveguide 26.

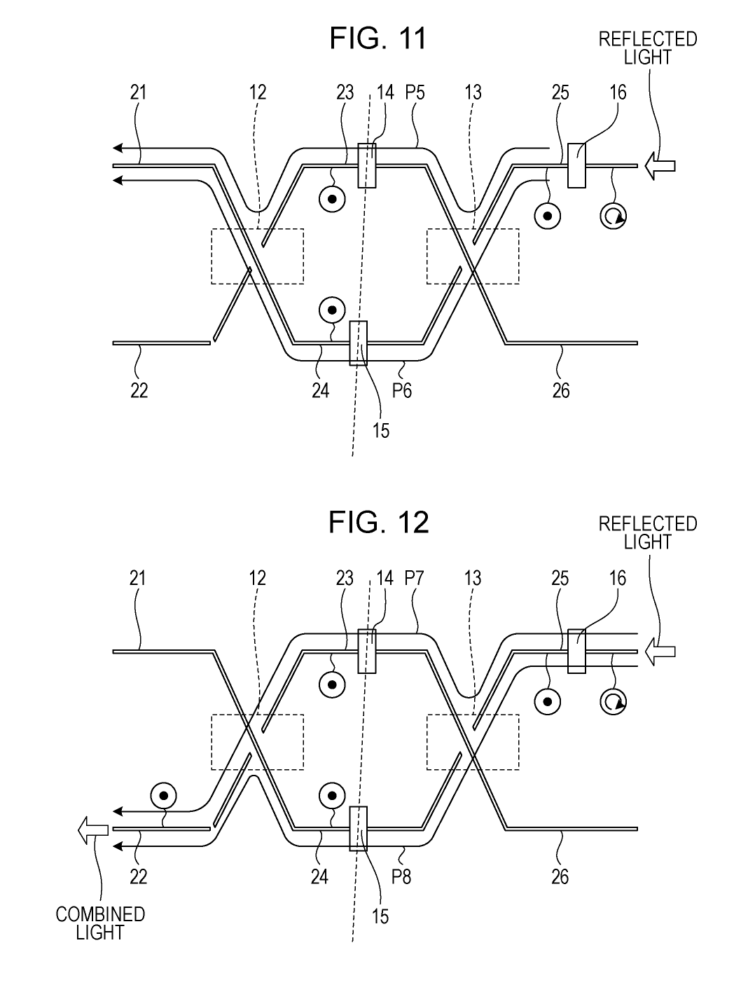

Next, a description is given of an operation of the optical isolator 1 to block the reflected light corresponding to the output light. FIGS. 11 and 12 are diagrams for explaining the operation of the optical isolator 1 to block the reflected light corresponding to the output light.

In FIG. 11, the output waveguide 25, first path, and input waveguide 21 constitute a route P5, and the output waveguide 25, second path, and input waveguide 21 constitute a route P6. In FIG. 12, the output waveguide 25, first path, and auxiliary waveguide 22 constitute a route P7, and the output waveguide 25, second path, and auxiliary waveguide 22 constitute a route P8.

A description is given of the operation of the optical isolator 1 in the routes P5 and P6 illustrated in FIG. 11. The output light output from the output waveguide 25 is circularly-polarized, and the reflected light corresponding to the output light is input to the output waveguide 25 as circularly-polarized light. The polarization converter 16 converts the polarization state of the reflected light into the polarization state perpendicular to that of the input light. When the polarization state of the reflected light is converted into the polarization state perpendicular to that of the input light, the polarization state of the reflected light is vertical to the surface of the substrate 10. Since the polarization state of the reflected light is converted into the polarization state perpendicular to that of the input light, therefore the reflected light, the light for traveling through the first path corresponding to the reflected light, and the light for traveling through the second path corresponding to the reflected light are s-polarized light.

The coupler 13 splits the reflected light input from the output waveguide 25 to generate third light to be input to the branch waveguide 23 and fourth light which is to be input to the branch waveguide 24 and has a phase shifted by π/2 with respect to the third light. The third light and fourth light are s-polarized light since the reflected light input from the output waveguide 25 is s-polarized light.

The phase adjuster 14 transmits the third light, which is s-polarized light, and does not adjust the phase of light for traveling through the first path. The phase adjuster 15 transmits the fourth light, which is s-polarized light, and does not adjust the phase of light for traveling through the second path.

The coupler 12 shifts the phase of the fourth light by π/2 to combine the fourth light with the phase shifted by π in total and the third light with the phase shifted by 0 in total at the input waveguide 21. The third light (light for traveling through the first path) and fourth light (light for traveling through the second path) are in antiphase at the input waveguide 21 and are canceled in the input waveguide 21. The reflected light is thereby blocked in the input waveguide 21.

A description is given of the operation of the optical isolator 1 in the routes P7 and P8 illustrate in FIG. 12. The output light output from the output waveguide 25 is circularly-polarized, and the reflected light corresponding to the output light is therefore input to the output waveguide 25 as circularly-polarized light. The polarization converter 16 converts the polarization state of the reflected light into the polarization state perpendicular to that of the input light. When the polarization state of the reflected light is converted into the polarization state perpendicular to that of the input light, the polarization state of the reflected light is vertical to the surface of the substrate 10. Since the polarization state of the reflected light is converted to the polarization state perpendicular to that of the input light, the reflected light, the light for traveling through the first path corresponding to the reflected light, and the light for traveling through the second path corresponding to the reflected light are s-polarized light.

The coupler 13 splits the reflected light input from the output waveguide 25 to generate the third light to be input to the branch waveguide 23 and the fourth light which is to be input to the branch waveguide 24 and has a phase shifted by π/2 with respect to the third light. Since the reflected light input from the output waveguide 25 is s-polarized light, the third light and fourth light are s-polarized light.

The phase adjuster 14 transmits the third light, which is s-polarized light, and does not adjust the phase of light for traveling through the first path. The phase adjuster 15 transmits the fourth light, which is s-polarized light, and does not adjust the phase of light for traveling through the second path.

The coupler 12 shifts the phase of the third light by π/2 to combine the third light with the phase shifted by π/2 in total and the fourth light with the phase shifted by π/2 in total at the auxiliary waveguide 22. The third light (light for traveling through the first path) and fourth light (light for traveling through the second path) are in phase at the auxiliary waveguide 22 and are combined at the auxiliary waveguide 22. The combined light of the third and fourth light is then output from the auxiliary waveguide 22.

As described above, the optical isolator 1 includes the optical waveguide 11, couplers 12 and 13, phase adjusters 14 and 15, and polarization converter 16. The optical waveguide 11 is formed on or in the substrate 10 and includes the input waveguide 21, which is configured to receive input light, the branch waveguides 23 and 24, and the output waveguide 25, which is configured to output output light corresponding to the input light. The coupler 12 connects the input waveguide 21 and branch waveguides 23 and 24 for splitting and combining light. The coupler 13 connects the output waveguide 25 and branch waveguides 23 and 24 for splitting and combining light. The phase adjuster 14 is provided to the branch waveguide 23 and adjusts the phase of light for traveling through the first path, which includes the coupler 12, branch waveguide 23, and coupler 13, depending on the polarization state of the light. The phase adjuster 15 is provided to the branch waveguide 24 and adjusts the phase of light for traveling through the second path, which includes the coupler 12, branch waveguide 24, and coupler 13, depending on the polarization state of the light. The polarization converter 16 is provided to the output waveguide 25. When the reflected light corresponding to the output light is input to the output waveguide 25, the polarization converter 16 converts the polarization state of the reflected light such that the light for traveling through the first path and the light for traveling through the second path are in antiphase at the input waveguide 21.

By the above-described configuration of the optical isolator 1, the reflected light is blocked without using a magneto-optical crystal having a larger coefficient of thermal expansion than that of the substrate 10 and optical waveguide 11. This reduces decrease in the reflected light blocking performance due to changes in temperature.

### Application Examples

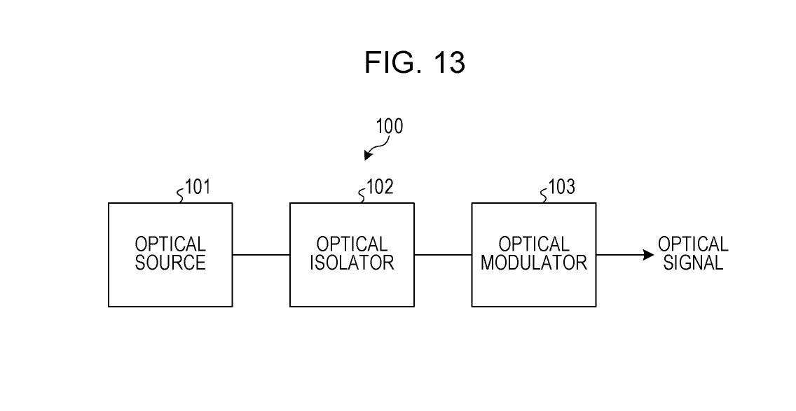

The optical isolator 1 described in the aforementioned embodiment is applicable to optical modules such as a transmitter that transmits optical signals, for example. FIG. 13 is a diagram illustrating the configuration of an optical module 100 with the optical isolator 1 according to the aforementioned embodiment mounted.

As illustrated in FIG. 13, the optical module 100 includes an optical source 101, an optical isolator 102, and an optical modulator 103. The optical source 101 includes a light emitting device such as a laser diode (LD), for example and generates optical source light. The optical source light generated in the optical source 101 is input to the optical isolator 102.

The optical isolator 102 is the optical isolator 1 described in the above embodiment. The optical isolator 102 transmits the optical source light from the optical source 101 and blocks the return of the reflected light to the optical source 101.

The optical modulator 103 modulates the optical source light transmitted through the optical isolator 102 to generate an optical signal. The optical modulator 103 transmits the generated optical signal out of the optical module 100.

Additional note 1. An optical isolator includes: an optical waveguide which is formed on or in a substrate and includes an input waveguide configured to receive input light, a first branch waveguide, a second branch waveguide, and an output waveguide configured to output output light corresponding to the input light; a first coupler configured to input the input light through the input waveguide and branch the input light into the first and second branch waveguides; a second coupler configured to combine the first branch waveguide and the second branch waveguide and to output combined light through the output waveguide; a phase adjuster provided to the second branch waveguide and configured to adjust a phase of light for traveling through a second path depending on a polarization state of the light, the second path including the first coupler, the second branch waveguide, and the second coupler; and a polarization converter provided to the output waveguide and configured to, when reflected light corresponding to the output light is input to the output waveguide, convert a polarization state of the reflected light such that a first part of the reflected light for traveling through the first path and a second part of the reflected light for traveling through the second path are in antiphase at the input waveguide.

Additional note 2. An apparatus includes: an optical source; and an optical isolator configured to transmit optical source light emitted from an optical source and block return of reflected light to the optical source, wherein the optical isolator includes: an optical waveguide which is formed on or in a substrate and includes an input waveguide configured to receive input light, a first branch waveguide, a second branch waveguide, and an output waveguide configured to output output light corresponding to the input light; a first coupler connecting the input waveguide and the first and second branch waveguides and configured to split and combine light; a second coupler connecting the output waveguide and the first and second branch waveguides and configured to split and combine light; a phase adjuster provided to the second branch waveguide and configured to adjust a phase of light for traveling through a second path depending on a polarization state of the light, the second path including the first coupler, the second branch waveguide, and the second coupler; and a polarization converter provided to the output waveguide and configured to, when reflected light corresponding to the output light is input to the output waveguide, convert a polarization state of the reflected light such that a first part of the reflected light for traveling through the first path and a second part of the reflected light for traveling through the second path are in antiphase at the input waveguide.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An apparatus comprising:
a first optical coupler configured to input input light through an input waveguide and branch the input light into first and second branch waveguides;
a second optical coupler configured to combine the first and the second branch waveguides and to output the output light through an output waveguide;
a phase adjuster having a birefringent property, provided to the second branch waveguide; and
a polarization converter having a birefringent property, provided to the output waveguide and configured to, when reflected light corresponding to the output light is input to the output waveguide, convert a polarization state of the reflected light such that a first part of the reflected light for traveling through the first path and a second part of the reflected light for traveling through the second path are in antiphase at the input waveguide.

2. An optical isolator comprising:
an optical waveguide which is formed on or in a substrate and includes an input waveguide configured to receive input light, a first branch waveguide, a second branch waveguide, and an output waveguide configured to output output light corresponding to the input light;
a first coupler configured to input the input light through the input waveguide and branch the input light into the first and second branch waveguides;
a second coupler configured to combine the first branch waveguide and the second branch waveguide and to output combined light through the output waveguide;
a phase adjuster provided to the second branch waveguide and configured to adjust a phase of light for traveling through a second path depending on a polarization state of the light, the second path including the first coupler, the second branch waveguide, and the second coupler; and
a polarization converter provided to the output waveguide and configured to, when reflected light corresponding to the output light is input to the output waveguide, convert a polarization state of the reflected light such that a first part of the reflected light for traveling through the first path and a second part of the reflected light for traveling through the second path are in antiphase at the input waveguide.

3. The optical isolator according to claim 2, wherein
the phase adjuster shifts the phase of light for traveling through the second path by π when the polarization state of the light for traveling through the second path is equal to the polarization state of the input light,
the phase adjuster does not shift the phase of light for traveling through the second path when the polarization state of the light for traveling through the second path is perpendicular to the polarization state of the input light, and
the polarization converter converts the polarization state of the reflected light into the polarization state perpendicular to the polarization state of the input light.

4. The optical isolator according to claim 2, wherein
the first coupler splits the input light input from the input waveguide to generate first light to be input to the first branch waveguide and second light which is to be input to the second branch waveguide and has a phase shift of π/2 with respect to the first light,
the phase adjuster shifts the phase of the second light by π to adjust the phase of the light for traveling through the second path,
the second coupler shifts the phase of the second light by π/2 to combine the first light with the phase shifted by 2π in total and the second light with the phase shifted by 2π in total at the output waveguide, and
the polarization converter converts the polarization state of the combined light of the first light and second light into circular-polarization.

5. The optical isolator according to claim 2, wherein
the polarization converter converts the polarization state of the reflected light into the polarization state perpendicular to the polarization state of the input light,
the second coupler splits the reflected light input from the output waveguide to generate third light to be input to the first branch waveguide and fourth light which is to be input to the second branch waveguide and has a phase shift of π/2 with respect to the third light,
the phase adjuster transmits the fourth light and thereby does not adjust the phase of the light for traveling through the second path,
the first coupler shifts the phase of the fourth light by π/2 and combines the third light with the phase shifted by 0 in total and the fourth light with the phase shifted by π in total at the input waveguide, causing the third light and fourth light to cancel each other.

6. The optical isolator according to claim 2, wherein
the optical waveguide further includes a first auxiliary waveguide adjacent to the input waveguide,
the first coupler connects the input waveguide, the first auxiliary waveguide, and the first and second branch waveguides, and
the polarization converter converts the polarization state of the reflected light such that the light for traveling through the first path and the light for traveling through the second path are in antiphase at the input waveguide and are in phase at the first auxiliary waveguide.

7. The optical isolator according to claim 2, wherein
the optical waveguide further includes a second auxiliary waveguide adjacent to the output waveguide,
the second coupler connects the output waveguide, the second auxiliary waveguide, and the first and second branch waveguides, and
in a process to output the output light from the output waveguide, the light for traveling through the first path and the light for traveling through the second path are in antiphase at the second auxiliary waveguide.

8. The optical isolator according to claim 2, wherein
the phase adjuster is made of the same material as that of the substrate, and
the polarization converter is made of a material which is different from the material of the substrate and has a coefficient of thermal expansion that is closer to the coefficient of thermal expansion of the material of the substrate than to the coefficient of thermal expansion of a magneto-optical crystal.

9. The optical isolator according to claim 2, wherein
each of the phase adjuster and the polarization converter is composed of a birefringent crystal having two optical axes with different indices of refraction, and
the polarization converter is arranged such that the directions of the two optical axes of the polarization converter are rotated by π/4 respectively with respect to the directions of the two optical axes in the phase adjuster.

10. An apparatus comprising:
an optical source; and
an optical isolator configured to transmit optical source light emitted from an optical source and block return of reflected light to the optical source, wherein
the optical isolator includes:
an optical waveguide which is formed on or in a substrate and includes an input waveguide configured to receive input light, a first branch waveguide, a second branch waveguide, and an output waveguide configured to output output light corresponding to the input light;
a first coupler connecting the input waveguide and the first and second branch waveguides and configured to split and combine light;
a second coupler connecting the output waveguide and the first and second branch waveguides and configured to split and combine light;
a phase adjuster provided to the second branch waveguide and configured to adjust a phase of light for traveling through a second path depending on a polarization state of the light, the second path including the first coupler, the second branch waveguide, and the second coupler; and
a polarization converter provided to the output waveguide and configured to, when reflected light corresponding to the output light is input to the output waveguide, convert a polarization state of the reflected light such that a first part of the reflected light for traveling through the first path and a second part of the reflected light for traveling through the second path are in antiphase at the input waveguide.

11. The optical isolator according to claim 1, wherein
the phase adjuster is a birefringent waveguide having a function of a half-wave plate.

12. The optical isolator according to claim 1, wherein
the polarization converter is a birefringent waveguide having a function of a quarter-wave plate.

13. The optical isolator according to claim 2, wherein
the phase adjuster is a half-wave plate.

14. The optical isolator according to claim 2, wherein
the phase adjuster is a birefringent waveguide having a function of a half-wave plate.

15. The optical isolator according to claim 2, wherein
the polarization converter is a quarter-wave plate.

16. The optical isolator according to claim 2, wherein
the polarization converter is a birefringent waveguide having a function of a quarter-wave plate.
